(19) United States
(12) Patent Application Publication
(10) Pub. No.: US 2020/0406171 A1
(43) Pub. Date: Dec. 31, 2020

(54) DIFFERENTIAL PRESSURE VALVE & FILTER SYSTEM INCORPORATING SAME

(71) Applicant: Parker-Hannifin Corporation, Cleveland, OH (US)

(72) Inventors: Thomas Muzik, Colorado Springs, CO (US); James H. Gammon, Manasquan, NJ (US); Kyle S. Rogachenko, Yardley, PA (US)

(21) Appl. No.: 16/677,061

(22) Filed: Nov. 7, 2019

Related U.S. Application Data
(60) Provisional application No. 62/866,104, filed on Jun. 25, 2019.

(51) Int. Cl. B01D 35/157; B01D 35/26; B01D 37/04; B01D 35/02; F16K 31/363; F16K 3/26; F16K 37/00; B67D 7/76; B64D 37/18; B64D 37/10

(52) U.S. Cl. CPC B01D 35/1573; B01D 35/26; B01D 37/046; B01D 35/023; B64D 37/10; F16K 3/26; F16K 37/0058; B67D 7/76; B64D 37/18; F16K 31/363

(57) ABSTRACT

A filter system with flow regulation includes a filter interposed along the fluid passageway and a differential valve in fluid series therewith. The valve may use the upstream reference hydraulic pressure at the filter inlet and a downstream hydraulic pressure thereof to generate a valve position that regulates fluid flow along the fluid passageway. This can partially restrict flow and reduce pressure differential across the filter system and effectively closes off flow through the system when pressure differential is high. This may be used in aircraft or other fueling applications to limit flow and cause the operator to change the fuel filter once fuel flow slows to a trickle when the differential valve effectively closes due to higher differential pressure. The valve is also capable of a fully closed position at high pressure differential state.

### CROSS-REFERENCE TO RELATED PATENT APPLICATIONS

This patent application claims the benefit of U.S. Provisional Patent Application No. 62/757,950, filed Nov. 9, 2018; and U.S. Provisional Patent Application No. 62/866,104, filed Jun. 25, 2019. The entire teachings and disclosure of which are incorporated herein by reference thereto.

### FIELD OF THE INVENTION

This invention generally relates to differential pressure control valves, and more particularly in relation to differential pressure control valves in filter systems with flow regulation such as may be applied in fuel filling and refueling applications.

### BACKGROUND OF THE INVENTION

In undertaking refueling fuel tank filling processes, such as in the aviation ground fuel market, fuel is typically pumped from a storage tank and passed through a filter unit along a fluid flow passageway through a fuel discharge hose to reach the fuel tank of an aircraft (or other similar apparatus such as another vehicle or engine). Limiting the pressure differential across the fuel filter is important in applications such as aviation to provide for proper filtration performance. The fueling operator is often required to monitor pressure differential in the fuel delivery process. This might be done electronically with electronic control. However, there are many instances where controlling the fuel differential pressure cannot be accomplished by electronic means.

Existing devices require a primary and secondary hydraulic actuated system which is complicated and costly requiring hydraulic actuation controls. There are also systems that perform this function that are electrical, but these systems are also costly and not all fueling locations have access to electricity.

### BRIEF SUMMARY OF THE INVENTION

According to an embodiment disclosed herein, a valve device provides for a direct acting differential pressure limiting device. For example, a spring over hydraulic actuated valve may be provided. The valve reduces the flow rate as it senses filter differential pressure and shuts the flow down at or before maximum allowable pressure differential is realized.

Embodiments may use differential pressure such as the upstream filter pressure to close a valve downstream of the housing as the differential pressure reaches its limit. The valve device advantageously may use only the system pressure to accomplish the task rather than relying on a secondary control system indicated in the background section, whether it be a hydraulic control or electrical control.

According to one aspect, a filter system with flow regulation, comprises: a filter system inlet; a filter system outlet; and a fluid passageway connecting the filter system inlet and the filter system outlet. A filter is interposed along the fluid passageway to filter fluid flowing from the filter system inlet to the filter system outlet. A differential valve is interposed along the fluid passageway in fluid series with the filter between the filter system inlet and the filter system outlet. The differential valve is subjected to an upstream hydraulic pressure that is upstream of the filter and a downstream hydraulic pressure that is downstream of the filter. The differential valve is movable in response to a differential pressure between the upstream hydraulic pressure and the downstream hydraulic pressure to regulate fluid flow along the fluid passageway.

Preferably, the differential valve may be arranged downstream of the filter.

The differential valve may include a fully open state when a low state of the pressure differential occurs, and a partially open state when an intermediate state of the pressure differential occurs, with the partially open state restricting fluid flow along the fluid passageway.

The differential valve may further have a fully closed state when a high state of the pressure differential occurs, with the fully closed state shutting off fluid flow through the fluid passageway.

In a more particular embodiment, the differential valve may comprise a valve element, a valve housing and a spring. The valve housing includes an inlet supply port and an outlet discharge port, with the valve element movable within the valve housing to regulate fluid flow between the inlet supply port and the outlet discharge port. A pressure chamber is formed between the valve housing and the valve element, with the valve housing having a pressure port connected to the upstream hydraulic pressure in communication the pressure chamber. When in use, hydraulic pressure in the pressure chamber applies a hydraulic force upon the valve element, with the spring biasing the valve element in opposition to the hydraulic force.

The valve housing may also comprise a housing cylinder with the valve element comprising a piston axially slidable in the housing cylinder.

In an even more specific embodiment, the piston may take the form of a valve spool having a first land and a second land separated by a stem to divide the housing cylinder into a pair of first and second end chambers and an intermediate chamber. The spring can be positioned in the second end chamber to act axially upon the second land of the valve spool, with the inlet supply port and the outlet discharge port connected via an open intermediate passageway through the intermediate chamber in an open position. The first land is movable to a closed position that blocks the intermediate fluid passageway when pressure in the first end chamber moves the valve spool against the action of the spring from the open position.

The first end chamber may open to a sight glass providing an indication of whether the valve spool is in the open position or the closed position.

In a more specific embodiment, the differential valve may also comprises a visual indicator coupled to and movable with the valve spool providing a visual indicator of pressure differential.

More generally, the differential valve can comprise an external visual indicator provided between the valve housing and the piston, including an indicator member coupled to and movable with the piston.

Preferably, the differential valve is free of an electrical or hydraulic actuator and free of electronic control.

Another aspect is directed toward a fuel delivery system for filling a fuel tank of an apparatus, the fuel delivery system incorporating such filter system (e.g. having a filter and differential valve) and further comprising: a fuel storage tank; a fuel discharge conduit having discharge control that permits selective discharge of fuel from an fuel output, the fuel output configured to be removably connectable to other apparatus for dispensing fuel into the fuel tank thereof; and a pump arranged to pump fuel through the filter and the differential valve to deliver filtered fuel to the fuel tank.

Another aspect is directed toward a differential pressure controlling valve. The valve includes a housing defining an internal chamber that includes an upstream pressure reference port into the internal chamber, a downstream inlet supply port into the chamber and a downstream outlet discharge port out of the chamber. A spring-activated shuttle defines a first chamber portion in fluid communication with the upstream pressure reference port, and a fluidly-separate, second chamber portion in fluid communication with the downstream inlet supply port and downstream outlet discharge port. The shuttle is moveable from i) a first, open position when a pressure differential between the upstream pressure reference port and the downstream inlet supply port is below a predetermined threshold wherein a flow path is open between the downstream inlet supply port and the downstream outlet discharge port, and i) a second, closed position when a pressure differential between the upstream pressure reference port and the downstream inlet supply port is above the predetermined threshold wherein the flow path is blocked between the downstream inlet supply port and the downstream outlet discharge port.

The differential pressure controlling valve may further include an external visual indicator device, which is in a first, non-visible position when the shuttle is in the open position, and a second, visible position when the shuttle is in the closed position.

The spring-activated shuttle may comprise a valve spool and a spring. The valve spool can have a first land and a second land separated by a stem to divide the housing into a pair of first and second end chambers and an intermediate chamber. The first end chamber provides the first chamber portion and the intermediate chamber provides the second chamber portion, with the spring being positioned at the second end chamber and acting axially upon the second land of the valve spool. The downstream inlet supply port and the downstream outlet discharge port are connected via an open intermediate passageway through the intermediate chamber in the open position. The first land is movable to the closed position that blocks the intermediate fluid passageway when pressure in the first chamber moves the valve spool against the action of the spring from the open position.

The first chamber may opens to a sight glass providing an indication of whether the valve spool is in the open position or the closed position.

The differential pressure controlling valve may further comprising a visual indicator coupled to and movable with the valve spool providing a visual indicator of pressure differential.

Preferably such a differential valve is free of an electrical or hydraulic actuator and free of electronic control.

Another aspect is directed toward a method of dispensing fuel (e.g. such as as fueling a tank of an aircraft or other such apparatus). The method comprises: pressurizing fuel along a fuel passageway to generate a first reference pressure; filtering the fuel with a filter, the filtering of fuel creating restriction and a pressure drop from the first reference pressure; regulating the discharge of fuel along the fuel passageway with a differential pressure controlling valve utilizing the pressure drop without electronic control.

The method may further comprise externally visually indicating on the differential controlling valve an indication of pressure drop.

The method may further comprise keeping the differential pressure controlling valve fully open when the pressure drop is below a first pressure differential value, and at least partially closing the differential pressure controlling valve when the pressure drop is above the first pressure differential value.

The method may further comprise effectively closing the differential pressure controlling valve when the pressure drop is above a second pressure differential value that is higher than the first pressure differential value.

The method may yet further comprise flowing the fuel first along the fuel passageway first through the filter and then in series through the differential pressure controlling valve. The method may further comprise porting the fuel at the first reference pressure at a location upstream of the filter to the differential pressure controlling valve, with the differential pressure controlling valve further comprising a housing defining an internal chamber, and including an upstream pressure reference port into the internal chamber receiving the first reference pressure, a downstream inlet supply port into the chamber and a downstream outlet discharge port out of the chamber. A spring-activated shuttle can define a first chamber portion in fluid communication with the upstream pressure reference port, and a fluidly-separate, second chamber portion in fluid communication with the downstream inlet supply port and downstream outlet discharge port, with the shuttle moveable to regulate fuel flow through the filter.

Preferrably, the differential pressure controlling valve is downstream of the filter.

In an application according to one embodiment, the method comprises: storing the fuel in a fuel storage tank; pumping the fuel through the filter and the differential pressure controlling valve to deliver filtered fuel to the fuel tanks of aircraft; and discharging downstream of the filter and the differential pressure controlling valve with a fuel discharge conduit having discharge control that permits selective discharge of fuel from a fuel output, the fuel output configured to be removably connectable to aircraft for dispensing fuel into the fuel tanks thereof.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic and partially cross-sectional illustration of a filter system with flow regulation according to a first embodiment, illustrating a differential valve arranged in an open position.

FIG. 2 is the same illustration of the filter system shown in FIG. 1, but in a high pressure differential state with the differential valve translated to a closed position.

FIG. 3 is an isometric view of an embodiment of a differential valve that may be used and employed in the filter system of FIG. 1 and/or in the fueling system shown in FIG. 6.

FIG. 4 is a side elevational view of the differential valve shown in FIG. 3.

FIG. 5 is a cross-section of the differential valve shown in FIG. 4 taken about section 5-5 of FIG. 4.

FIG. 6 is a schematic representation of a fuel system such as for refueling and filling tanks of aircraft in accordance with an embodiment of the present invention that may incorporate the differential valve as shown in either FIGS. 3-5 or more generically as the valve as schematically indicated in FIGS. 1 and 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

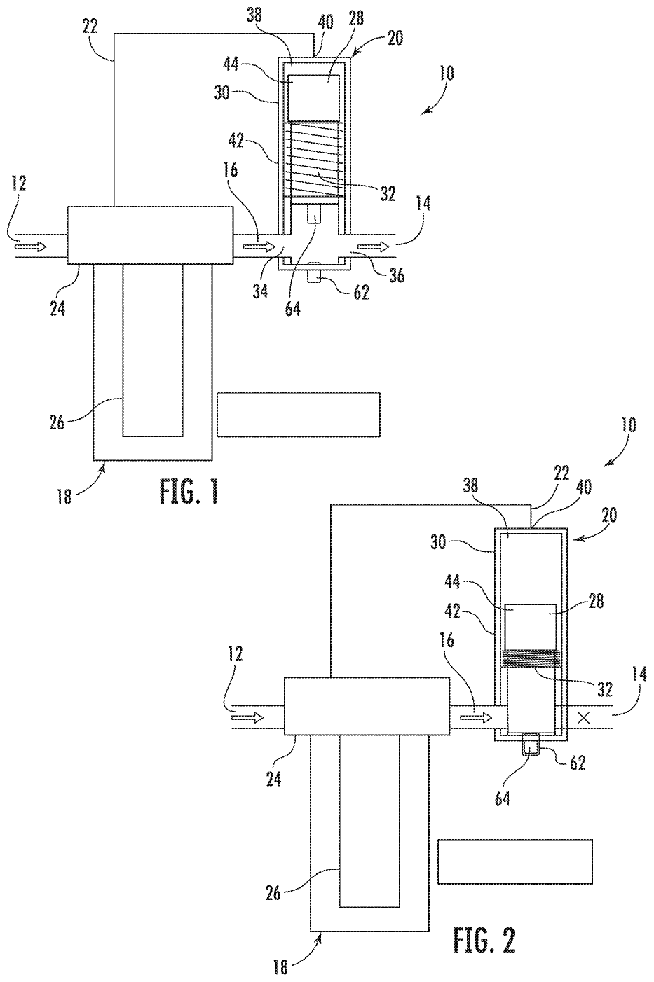

In accordance with an embodiment of the present invention, FIGS. 1-2 illustrate schematic views of a filter system 10 with flow regulation, with FIG. 1 illustrating the system at a clean differential pressure and FIG. 2 illustrating the system at a maximum differential pressure such as due to the filter being occluded with particulate. The filter system 10 comprises a filter system inlet 12, a filter system outlet 14, and a fluid passageway 14 connecting the inlet 12 with the outlet 14. A filter 18 is interposed along the fluid passageway 16 to filter fluid flowing from the inlet 12 to the outlet 14. Further, a differential pressure valve 20 is interposed along the fluid passageway 16 as well in fluid series with the filter 18 between the inlet 12 and the outlet 14.

When the differential pressure valve 20 is open as shown in FIG. 1, fluid such as fuel is allowed to flow through the filter 18 whereby particulate is filtered out of the fuel and passes through the differential pressure valve 20 to the outlet 14. However, when the filter 18 becomes clogged (e.g. has reached its lifespan), it creates higher pressure differential that causes the differential pressure valve 20 to close thereby shutting off fuel flow along the fluid passageway from the inlet 12 to the outlet 14 as schematically indicated in FIG. 2. As may be realized in typical refueling applications, and while the differential pressure valve 20 includes a fully closed state as illustrated in FIG. 2, in practice it will more typically undergo an “effectively” closed state whereby the valve is closed to shut off most of the fuel flow through the system and limit the differential pressure causing the flow to reduce to a trickle annoying the refueling operator and indicating to the operator that the filter thereby needs to be changed. Thus, the valve 20 may also operate to limit and control the amount of differential pressure and lower the pressure by partially closing the flow path in an intermediate state because at high pressure, it can force undesirable particulates through the filter.

The differential pressure valve 20 is subjected such as by way of pressure sensing communication passage 22 to an upstream hydraulic pressure that is upstream of the filter (which is upstream of the particulate filter element contained within the filter and a downstream hydraulic pressure that is downstream of the filter such as experienced at outlet 14). As illustrated in comparing FIGS. 1 and 2, the differential pressure valve 20 is movable in response to a differential pressure between the upstream hydraulic pressure and the downstream hydraulic pressure to regulate fluid flow along the fluid passageway 16. It is noted that as shown in FIGS. 1 and 2, preferably the communication passage 22 may be connected directly to the filter housing 30 upstream of the particulate filter element 26 contained therein such that the communication passage 22 is communicating the upstream hydraulic pressure to the differential pressure valve 20. In in this instance and as shown, the differential pressure valve is thus subjected to an upstream hydraulic pressure that is upstream of the filter. However, it is also envisioned that in an alternative embodiment the communication passage 22 may connect to a portion of the fluid passageway 16 before reaching the filter housing 26 and is thus also still subjected to an upstream pressure that is upstream of the filter.

Preferably, the differential pressure valve 20 is arranged downstream of the filter 18. This makes it easier for the valve 20 to be readily subjected to the downstream pressure. However, it is also possible to move the differential pressure valve 20 to an upstream location of the filter 18 in an alternative embodiment and communicate the downstream pressure to the valve 20 that is then already experiencing the upstream hydraulic pressure as well.

In operation, the differential pressure valve 20 has a fully open state as shown in FIG. 1 when a low state of pressure differential occurs, and a partially open state when an intermediate state of the pressure differential occurs (which corresponds to an intermediate position of the valve between that of FIGS. 1 and 2). The partially open state restricts fluid flow along the fluid passageway and serves to reduce the pressure differential such that more time is afforded for fuel to flow through the filter 18 and maintains a more limited range of pressure differential which is experienced by the filter 18. As shown schematically in FIG. 1, filter 18 includes a filter housing 24 (which may either be a filter head or complete filter enclosure) and a replaceable particulate filter element 26. For aviation fueling applications, suitable filter elements may include models VF-61, VF-61E; or VF-62 sold under the mark Aquacon® Filter Cartridges available from Parker Hannifin Corporation, Velcon Filtration Division. These are suitable both for fuel as well as oil applications or other such solvents.

In an embodiment, the pressure differentials across the filter may be set at a low state of between ⅓ to ⅔ of the high state (in other words the low state being set as to when the valve would begin to close for example in the case of a high state of 15 psi, a low state may be set between 5 and 10 psi). For the intermediate state, the setting may be between the remaining range between the high state and the low state. And the high state may be set to cause complete closure that would occur between 15 and 24 psi (the high state establishing when the valve is effectively closed to fuel flow, and typically fully closed). As such, the high state is higher than the low state typically by at least ⅓ to ⅔ of the high state with the intermediate state comprising a range covering about ⅓ of the high state. Typical flow rates for conventional aircraft fueling which is a significant application (but not only application) of the present embodiment when in the open position such as shown in FIG. 1 would be between 200 and 500 gallons per minute, and more typically between 40 and 250 gallons per minute in some embodiments. The reason for the large range is that it will be appreciated that larger or smaller refueling systems may be provided with correspondingly larger or smaller valves and filters.

As shown schematically in FIG. 1, the differential pressure valve 20 comprises a valve element 28, a valve housing 30, and a spring 32. The valve housing 30 includes an inlet supply port 34 and an outlet discharge port 36. The valve element 28 is movable within the valve housing to regulate fluid flow between the supply port 34 and the discharge port 36. Further, a pressure chamber 38 is formed between the valve housing 30 and the valve element 28. The valve housing 30 has a sensing pressure port 40 connected to the upstream hydraulic pressure (e.g. by way of previously described communication passage 22) with that port being in communication with the pressure chamber 38, such that when in use, hydraulic pressure in the pressure chamber 38 applies a hydraulic working force upon the valve element 28. To provide an opposing force, the spring 32 is provided and biases the valve element 28 in opposition to the hydraulic force and urges the valve element 28 toward the open position as illustrated schematically in FIG. 1. As shown in FIG. 2, when higher pressure is experienced via communication passage 22 to pressure port 40 and into pressure chamber 38, a higher hydraulic force is generated and acts upon the valve element 28 to compress and work against the action of the spring 32 and thereby compress the spring 32 and move the valve element 28 to the closed position as shown in FIG. 2.

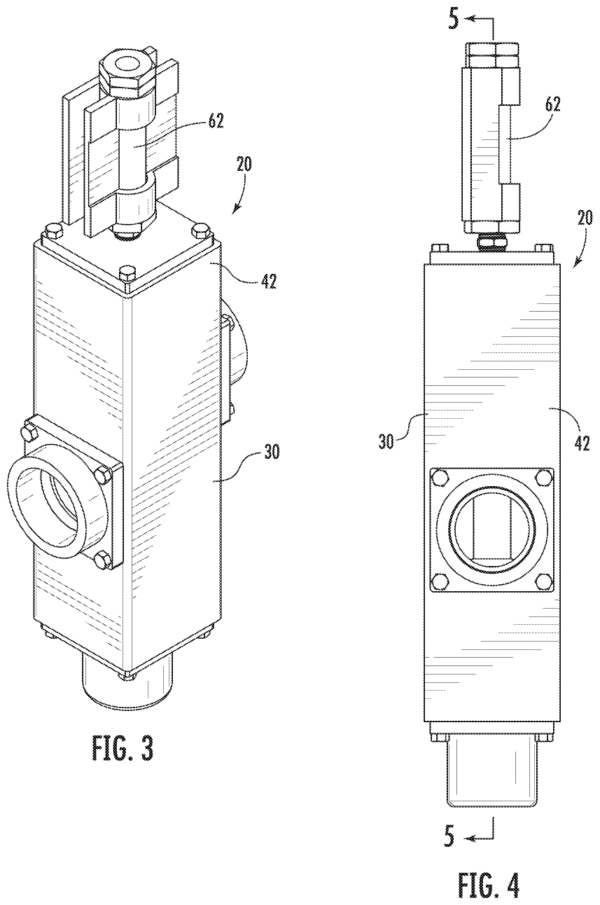

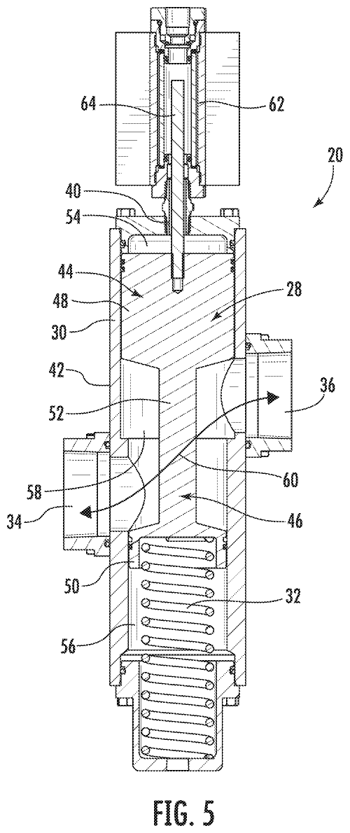

Turning to FIGS. 3-5, a more detailed structural embodiment of a differential pressure valve 20 is illustrated and as such, the same reference numerals will be provided considering that the structurally more detailed and developed valve shown in FIGS. 3-5 is usable for the valve schematically shown in FIGS. 1 and 2. As illustrated, the valve housing 24 generally includes a housing cylinder 42, and the valve element 28 may be provided by a piston 44 slidable in the housing cylinder 42.

As shown in FIGS. 3-5, the piston 44 may take the form of a valve spool 46 having first and second lands 48, 50, separated and connected by a stem 52 to divide the housing cylinder into a pair of first and second end chambers 54, 56, as well as an intermediate chamber 58 that is in surrounding relation of the stem 52. The spring 32 which may simply be a compressible coil spring as illustrated, and may be positioned in the second end chamber 56 (which may be vented to atmosphere) to act axially upon the second land 50 of the valve spool 46. Further, in this embodiment the inlet supply port 34 and the outlet discharge port 36 are connected via an open intermediate passageway 60 (which is part of the overall fluid passageway 16) and through the intermediate chamber 58 in an open or partially open position. The first land 48 is movable to a closed position (e.g. such as shown in FIG. 2) that blocks the intermediate passageway 60 when pressure in the first end chamber moves the valve spool 46 against the action of the spring 32 from the open position.

Further, preferably or optionally, the valve may further include an external visual indicator 64 which may be provided at one end or the other such as shown in comparing the schematic view of FIGS. 1 and 2 with a more detailed embodiment shown in FIGS. 3-5. According to the embodiment shown in FIGS. 3-5, the first end chamber can open to a sight glass 62 that can provide an indication of whether the valve spool 46 is in an open position or the closed position, or some intermediate position therebetween. For example, visual indicator 64 may indicate the level of lifespan left for the filter 18. Most preferably, a visual indicator 64 such as being provided by a cantilevered extension rod movable and visible in sight glass 62 as shown can be coupled to, and thereby movable with, the valve spool 60 (or any part of the valve element 28) to provide a visual indicator of pressure differential.

Accordingly, this provides an external visual indicator that is provided between the valve housing and the piston and includes an indicator coupled to and movable with the valve piston.

As readily evident in the embodiment shown in FIGS. 1 and 2, as well as in FIGS. 3-5, the differential pressure valve 20 is free of any electrical or hydraulic actuator and free of any electronic control in a preferred implementation. In other words, a separate hydraulic actuator need not be provided, but the valve is simply subjected to upstream and downstream pressure to regulate flow along the fluid passageway 16.

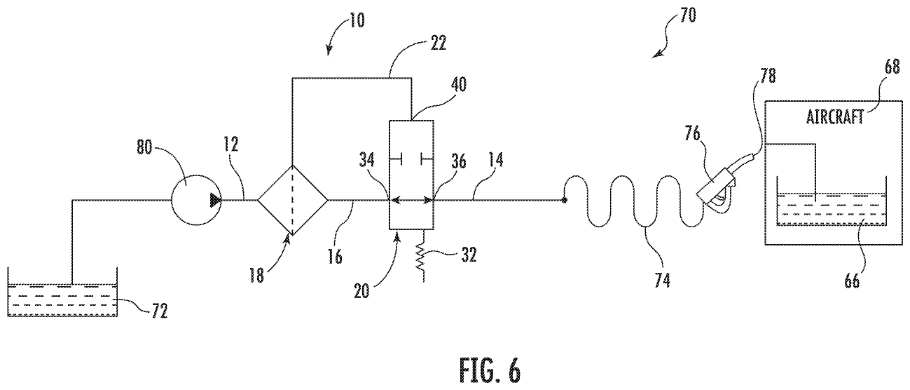

Turning to FIG. 6, the filter system 10 with flow regulation including the differential pressure valve 20 as well as the filter 18 thereof can be integrated into a fuel delivery system such as for filling (e.g. refueling) a fuel tank of another apparatus, such as the fuel tank 66 of an aircraft 68 as schematically indicated in FIG. 6. Such a fuel delivery system 70 includes a fuel storage tank 72, a fuel discharge conduit 74 that has a discharge control 76 (e.g. a hand operated on and off valve of a typical fuel discharge nozzle of a fuel hose) that permits selective discharge of fuel from the fuel output such as the discharge nozzle. The fuel output 78 is configured to be removably connectable to other apparatus such as the aircraft 68 for dispensing fuel into the fuel tank 66 thereof. For example, in typical application the operator will install the discharge nozzle into the filling port leading to the aircraft fuel tank 66. Further, typically a fuel pump 80 is arranged to pump fuel through the filter 18 and the differential pressure valve 20 in order to deliver filtered fuel to the fuel tank 66.

In comparing the schematic illustration of the valve shown in FIGS. 1 and 2 with that of FIGS. 3-5, it can be seen that in both situations there is illustrated to be a valve piston that may be referenced as a shuttle valve which in more simplified schematic form shown in FIGS. 1 and 2 may not necessarily be in the more specific detailed structural configuration of a spool valve such as shown in FIGS. 3-5. However, in each situation there is provided a spring actuated shuttle to provide for the movable valve element.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter system with flow regulation, comprising:
a filter system inlet;
a filter system outlet;
a fluid passageway connecting the filter system inlet and the filter system outlet;
a filter interposed along the fluid passageway to filter fluid flowing from the filter system inlet to the filter system outlet;
a differential valve interposed along the fluid passageway in fluid series with the filter between the filter system inlet and the filter system outlet, the differential valve being subjected to an upstream hydraulic pressure that is upstream of the filter and a downstream hydraulic pressure that is downstream of the filter, wherein the differential valve is movable in response to a differential pressure between the upstream hydraulic pressure and the downstream hydraulic pressure to regulate fluid flow along the fluid passageway.

2. The filter system of claim 1, wherein the differential valve is arranged downstream of the filter.

3. The filter system of claim 1, wherein the differential valve includes a fully open state when a low state of the pressure differential occurs, and a partially open state when an intermediate state of the pressure differential occurs, the partially open state restricting fluid flow along the fluid passageway.

4. The filter system of claim 2, wherein the differential valve further has a fully closed state when a high state of the pressure differential occurs, the fully closed state shutting off fluid flow through the fluid passageway.

5. The filter system of claim 1, wherein the differential valve comprises a valve element, a valve housing and a spring, the valve housing including an inlet supply port and an outlet discharge port, the valve element movable within the valve housing to regulate fluid flow between the inlet supply port and the outlet discharge port, a pressure chamber formed between the valve housing and the valve element, the valve housing having a pressure port connected to the upstream hydraulic pressure in communication the pressure chamber wherein when in use hydraulic pressure in the pressure chamber applies a hydraulic force upon the valve element, wherein the spring biases the valve element in opposition to the hydraulic force.

6. The filter system of claim 5, wherein the valve housing comprises a housing cylinder and wherein the valve element comprises a piston axially slidable in the housing cylinder.

7. The filter system of claim 6, wherein the piston is in the form of a valve spool having a first land and a second land separated by a stem to divide the housing cylinder into a pair of first and second end chambers and an intermediate chamber, the spring being positioned in the second end chamber and acting axially upon the second land of the valve spool, the inlet supply port and the outlet discharge port connected via an open intermediate passageway through the intermediate chamber in an open position, the first land being movable to a closed position that blocks the intermediate fluid passageway when pressure in the first end chamber moves the valve spool against the action of the spring from the open position.

8. The filter system of claim 7, wherein the first end chamber opens to a sight glass providing an indication of whether the valve spool is in the open position or the closed position.

9. The filter system of claim 8, further comprising a visual indicator coupled to and movable with the valve spool providing a visual indicator of pressure differential.

10. The filter system of claim 7, further comprising an external visual indicator provided between the valve housing and the piston, including an indicator member coupled to and movable with the piston.

11. The filter system of claim 1, wherein the differential valve is free of an electrical or hydraulic actuator and free of electronic control.

12. A fuel delivery system for filling a fuel tank of an apparatus, the fuel delivery system incorporating the filter system of claim 1, and further comprising:
a fuel storage tank;
a fuel discharge conduit having discharge control that permits selective discharge of fuel from an fuel output, the fuel output configured to be removably connectable to other apparatus for dispensing fuel into the fuel tank thereof;
a pump arranged to pump fuel through the filter and the differential valve to deliver filtered fuel to the fuel tank.

13. A differential pressure controlling valve, the valve including a housing defining an internal chamber, and including an upstream pressure reference port into the internal chamber, a downstream inlet supply port into the chamber and a downstream outlet discharge port out of the chamber, a spring-activated shuttle defining a first chamber portion in fluid communication with the upstream pressure reference port, and a fluidly-separate, second chamber portion in fluid communication with the downstream inlet supply port and downstream outlet discharge port, the shuttle moveable from i) a first, open position when a pressure differential between the upstream pressure reference port and the downstream inlet supply port is below a predetermined threshold wherein a flow path is open between the downstream inlet supply port and the downstream outlet discharge port, and i) a second, closed position when a pressure differential between the upstream pressure reference port and the downstream inlet supply port is above the predetermined threshold wherein the flow path is blocked between the downstream inlet supply port and the downstream outlet discharge port.

14. The differential pressure controlling valve of claim 13, further including an external visual indicator device, which is in a first, non-visible position when the shuttle is in the open position, and a second, visible position when the shuttle is in the closed position.

15. The differential pressure controlling valve of claim 13, wherein the spring-activated shuttle comprises a valve spool and a spring, the valve spool having a first land and a second land separated by a stem to divide the housing into a pair of first and second end chambers and an intermediate chamber, the first end chamber providing the first chamber portion and the intermediate chamber providing the second chamber portion, the spring being positioned at the second end chamber and acting axially upon the second land of the valve spool, the downstream inlet supply port and the downstream outlet discharge port connected via an open intermediate passageway through the intermediate chamber in the open position, the first land being movable to the closed position that blocks the intermediate fluid passageway when pressure in the first chamber moves the valve spool against the action of the spring from the open position.

16. The differential pressure controlling valve of claim 15, wherein the first chamber opens to a sight glass providing an indication of whether the valve spool is in the open position or the closed position.

17. The differential pressure controlling valve of claim 16, further comprising a visual indicator coupled to and movable with the valve spool providing a visual indicator of pressure differential.

18. The differential pressure controlling valve of claim 13, wherein the differential valve is free of an electrical or hydraulic actuator and free of electronic control.

19. A method of dispensing fuel, comprising:
pressurizing fuel along a fuel passageway to generate a first reference pressure;
filtering the fuel with a filter, the filtering of fuel creating restriction and a pressure drop from the first reference pressure;
regulating the discharge of fuel along the fuel passageway with a differential pressure controlling valve utilizing the pressure drop without electronic control.

20. The method of claim 19, further comprising externally visually indicating on the differential controlling valve an indication of pressure drop.

21. The method of claim 19, further comprising keeping the differential pressure controlling valve fully open when the pressure drop is below a first pressure differential value, and at least partially closing the differential pressure controlling valve when the pressure drop is above the first pressure differential value.

22. The method of claim 21, further comprising effectively closing the differential pressure controlling valve when the pressure drop is above a second pressure differential value that is higher than the first pressure differential value.

23. The method of claim 19, further comprising flowing the fuel first along the fuel passageway first through the filter and then in series through the differential pressure controlling valve, further comprising porting the fuel at the first reference pressure at a location upstream of the filter to the differential pressure controlling valve, the differential pressure controlling valve further comprising a housing defining an internal chamber, and including an upstream pressure reference port into the internal chamber receiving the first reference pressure, a downstream inlet supply port into the chamber and a downstream outlet discharge port out of the chamber, a spring-activated shuttle defining a first chamber portion in fluid communication with the upstream pressure reference port, and a fluidly-separate, second chamber portion in fluid communication with the downstream inlet supply port and downstream outlet discharge port, the shuttle moveable to regulate fuel flow through the filter.

24. The method of claim 23, wherein the differential pressure controlling valve is downstream of the filter.

25. The method of claim 19, further comprising:
storing the fuel in a fuel storage tank;
pumping the fuel through the filter and the differential pressure controlling valve to deliver filtered fuel to the fuel tanks of aircraft; and
discharging downstream of the filter and the differential pressure controlling valve with a fuel discharge conduit having discharge control that permits selective discharge of fuel from a fuel output, the fuel output configured to be removably connectable to aircraft for dispensing fuel into the fuel tanks thereof.
